(19) United States
(12) Patent Application Publication
(10) Pub. No.: US 2026/0107248 A1
(43) Pub. Date: Apr. 16, 2026

(54) ENABLING COMMUNICATION BETWEEN NETWORK FUNCTIONS IN A VISITING NETWORK TO DETERMINE LOCATION OF ROAMER

(71) Applicant: T-MOBILE INNOVATIONS LLC, Overland Park, KS (US)

(72) Inventors: Srinivasa Rao BODAPOTULA, Bellevue, WA (US); Romil Kumar SOOD, Bothell, WA (US)

(21) Appl. No.: 18/916,495

(22) Filed: Oct. 15, 2024

(51) Int. Cl. H04W 64/00; H04W 8/02

(52) U.S. Cl. CPC H04W 64/00; H04W 8/02

(57) ABSTRACT

The present disclosure is directed to determining location information of a roamer of a visiting network. A location network function (NF) may request for location information associated with the roamer of the visiting mobile communication network. The NF may request a roaming location identifier from a roaming NF. The location NF receives the roaming location identifier, which may be associated with a mobility NF. The location NF may request the location information from the mobility NF associated with the roaming location identifier.

### SUMMARY

The present disclosure is directed, in part to determining location information of a roamer of a visiting network, substantially as shown and/or described in connection with at least one of the figures, and as set forth more completely in the claims.

According to various aspects of the technology, mobile communications networks often host roaming subscribers (i.e., roamers) of other mobile networks (i.e., a home network) who temporarily access and use the mobile communications network (i.e., a visiting network) when visiting an area associated with the visiting network. Occasionally, a requestor may request the location of a roamer (e.g., lawful intercept by law enforcement). While a visiting network can easily provide the locations of its own subscribers, a visiting network may be unable to determine a location of the roamer without assistance from the roamer’s home network. The roamer’s home network may have dated infrastructure, delayed responses, or lack cooperation with the visiting network. As a result, network operators may be unable to provide the requestor with the location of the roamer. To avoid this result and comply with regulatory requirements, the present disclosure contemplates determining a roamer’s location without direct assistance from the home network by enabling communication between various NFs.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a call flow diagram of an exemplary method for determining location information of a roamer of a visiting network in which implementations of the present disclosure may be employed;

FIG. 4 illustrates a block flow diagram of an exemplary method for determining location information of a roamer of a visiting network in which implementations of the present disclosure may be employed; and

FIG. 5 illustrates a block flow diagram of an exemplary method for exchanging information between a location NF and a roaming NF in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, mobile communications networks often host roaming subscribers of other mobile networks (i.e., a home network) who temporarily access and use the mobile communications network (i.e., a visiting network) when visiting an area associated with that visiting network. Mobile network operators may have mutual agreements allowing a roamer’s use of the visiting network when in a visiting area, improving the traveling experiences of all subscribers of the home and visiting networks. For example, a roamer from Canada may enter the United States and use local visiting networks to make calls, obtain data services, and send SMS messages. Occasionally, for example, a roamer may be the target of an investigation by an entity within the visiting country, and the entity may request the roamer’s location from the visiting network. While a visiting network can easily provide the locations of its own subscribers, a visiting network may be unable to determine a location of the roamer without the direct assistance of the roamer’s home network, and as a result, the visiting network may be unable to provide the requestor (e.g., law enforcement agency (LEA)) with the location of the roamer. For example, a roamer makes unauthorized entry into a country, and law enforcement or other entities may request the location of the roamer. Due to an inability of a location network function (NF) to determine which mobility NF is being used by the roamer, the visiting network is unable to satisfy this request, and the unauthorized roamer is unable to be detained.

Conventionally, a request for the location of a particular roamer is routed through the home network, as the home network maintains the roamer’s location within home subscriber service (HSS) components. As a result, the location request may be routed to a home network with dated and/or unsuitable infrastructure, stricter privacy regulations, and/or that lacks interoperability with the visiting network. Location requests to such home networks may be delayed or go unanswered and any responses may be inaccurate. While the request is routed to the home network, it is the visiting network that is subject to regulatory requirements to provide this location under certain circumstances. Thus, a visiting network may not indiscriminately rely on the home network to provide the location of a roamer, and systems and methods enabling the visiting network to determine the location of a roamer without assistance from the home network are increasingly valuable.

In contrast to conventional solutions, the present disclosure is directed to determining the roamer’s location without direct assistance from the home network by enabling communication between NFs. A mobility NF (e.g., a mobility and management entity (MME), an access and mobility function (AMF)) may interact with a location NF (e.g., an evolved serving mobile location center (E-SMLC)) to obtain the location of a roamer. However, requests from third parties are received by a different location NF (e.g., a gateway mobile location center (GMLC)) that is unaware of which mobility NF is serving the roamer. Thus the GMLC, for example, is unaware of which mobility NF to request location information from regarding the roamer. By enabling the GMLC to determine the mobility NF associated with the roamer, the GMLC may request the mobility NF retrieve the location of the roamer. This solution provides a more reliable approach to determine the location of a roamer and does not require the assistance of the home network.

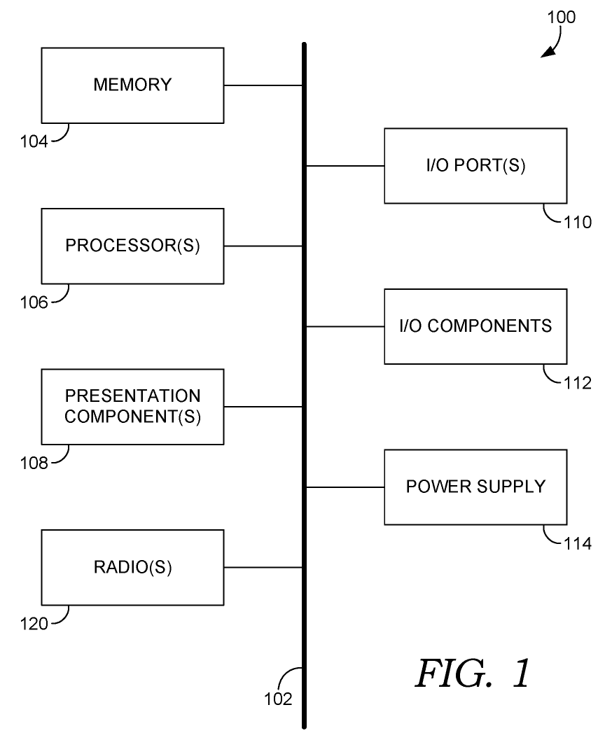

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

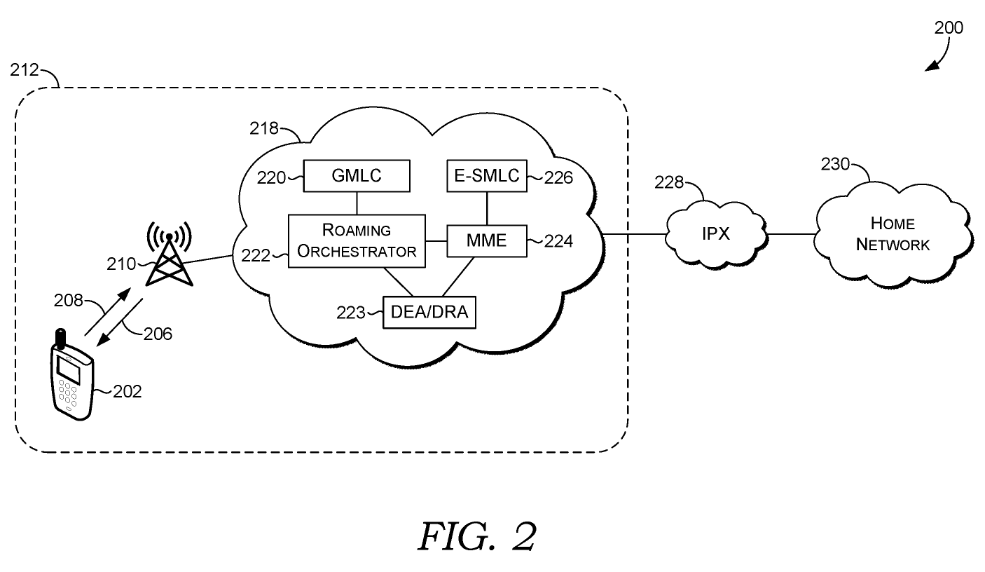

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise one or more UEs, such as a UE 202, one or more base stations of a visiting network 212, such as a base station 210, a core network 218 of the visiting network 212, an IP exchange (IPX) 228, and a home network 230, though in some implementations, it may not be necessary for certain features to be present. Similarly, while each component is shown in the singular, it is expressly contemplated that there may be more than one of the components described. The network environment may include a number of routers, switches, and the like. The network environment 200 is generally configured for wirelessly connecting the UE 202 to data or services that may be accessible on one or more application servers or other functions, nodes, or servers not pictured in FIG. 2 so as to not obscure the focus on the present disclosure.

The network environment 200 comprises the UE 202. The UE 202 is illustrated generally, and may take any number of forms, including a tablet, phone, or wearable device, or any other device discussed with respect to FIG. 1 and may have any one or more components or features of the computing device 100 of FIG. 1. In aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the base station 210 to which the UE 202 may potentially connect to (also referred to as ‘camping on,’ ‘attaching,’ in the industry). Though network environment 200 is illustrated with one base station 210, one skilled in the art will appreciate that more or fewer base stations may be present in any particular network environment. The base station 210 of the network environment 200 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The base station 210 is configured to communicate with one or more UEs, such as the UE 202. The base station 210 may communicate signals to one or more UEs via a downlink 206 and receive signals from one or more UEs via uplink 208. In response to receiving certain requests to and/or from the UE 202, the base station 210 may communicate with the core network 218 via a backhaul 214. For example, in order for the UE 202 to connect to a desired network service (e.g., PSTN call, voice over LTE (VoLTE) call, voice over new radio (VoNR), data, or the like), the UE 202 may communicate an attach request to the base station 210, which may, in response, communicate a registration request to the core network 218 via the backhaul 214.

The core network 218 may comprise one or more network functions (NFs). As used herein, the term “network function” is used to describe a computer processing module and/or one or more computer executable services being executed on one or more computing processing modules. The core network 218 may comprise NFs that include any one or more of a gateway mobile location center (GMLC) 220, a roaming orchestrator 222, a diameter edge agent and/or a diameter routing agent (DEA/DRA) 223, mobility management entity (MME) 224, and an evolved serving mobile location center (E-SMLC) 226. Each of the preceding NFs may take different forms, including consolidated or distributed forms that perform the same general operations. In other architectures or protocols, the NFs may be given other names, however, the NFs herein refer to functions, not specifically identified components. For example, the MME 224 may instead be an access and mobility function (AMF), the DEA/DRA 223 may be a security edge protection proxy (SEPP). The core network 218 may be configured according to one or more architectures (e.g., S8 home routing (S8HR), local breakout (LBO), home routing, hub breakout (HBO), and the like). In aspects, the core network 218 is an IP Multimedia Subsystem (IMS) network.

Though the GMLC 220, the roaming orchestrator 222, the DEA/DRA 223, the MME 224, and the E-SMLC 226 are illustrated in the core network 218, the core network 218 may have more or fewer NFs than shown. For example, the core network 218 may include a serving gateway (SGW), a packet data network gateway (PGW), a visitor location register (VLR), and the like. Further, though the GMLC 220, the roaming orchestrator 222, the DEA/DRA 223, the MME 224, and the E-SMLC 226 are illustrated as disposed within the core network 218, it is expressly contemplated that the location in the network environment 200 is non-limiting. For example, the NFs described above may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above. For example, in some aspects, there may be more than one MME 224 and/or more than one E-SMLC 226.

NFs within the core network 218 are defined by their function, as the core network 218 is a service-based architecture. The GMLC 220, for example, is generally responsible for managing location services, as well as receive and respond to location-based requests. The roaming orchestrator 222, for example, is generally responsible for controlling and managing roaming agreements, policies, and enforcement of these policies and agreements. In aspects, the roaming orchestrator 222 is a roaming customer experience management (RCEM) function. The DEA/DRA 223, for example, is generally responsible for securely managing and optimizing the routing of messages outside of the visiting network 212, ensuring secure communication with external networks (e.g., the home network 230). The MME 224, for example, is generally responsible for managing mobility, sessions, and signaling for users of networks, such as authentication and session handover. The E-SMLC 226, for example, is generally responsible for providing location services and determining a precise location of a particular user within the network (e.g., a roamer). Each of these NFs may communicate with each other, directly or indirectly, via interfaces existing between them.

The core network may communicate with the IPX 228, such as to communicate with the home network 230. The IPX 228 generally facilitates interconnectivity between different networks, such as between two distinct mobile communication networks. In aspects, the IPX 228 is an IP transit NF, an internet exchange point (IXP), a roaming hub, and the like. The home network 230 may be associated with the roamer. For example, the roamer, when at their home country, connects to the home network 230. In aspects, the home network 230 is a network where the roamer’s mobile subscription is registered. In some aspects, the home network 230 is a public network, and in other aspects, the home network 230 may a private network, a non-terrestrial network, and the like. The home network 230 may include one or more network nodes (e.g., base stations, satellites) configured to communicate with one or more UEs in an area associated with the home network 230.

Relevant to the present disclosure, a request for the location of a particular roamer is conventionally routed through the home network 230, which is undesirable for a number of reasons (e.g., the home network’s 230 dated and/or unsuitable infrastructure, stricter privacy regulations, and/or lack interoperability with the visiting network 212). Any requests for the roamer’s location (e.g., from a law enforcement agency) may be delayed or not received and responses from the home network 230 may be inaccurate or go unanswered. The MME 224 is able to determine the location of a roamer by requesting the location of the roamer from the E-SMLC 226 and/or providing tracking information associated with a served area of the MME 224. However, requests for location information often originate at the GMLC 220, and the GMLC 220 is unaware of the particular MME 224 serving the roamer. In any particular network, there may be hundreds or thousands of MMEs (e.g., the MME 224). As a result, the GMLC 220 is unable to process the request because it does not know which MME to request the roamer’s location from. To avoid this result, the present disclosure is directed to enabling communication between NFs (e.g., the GMLC 220 and the roaming orchestrator 222), by providing one or more interfaces between them to allow the visiting network 212 to determine the location of a roamer without participation by the home network 230.

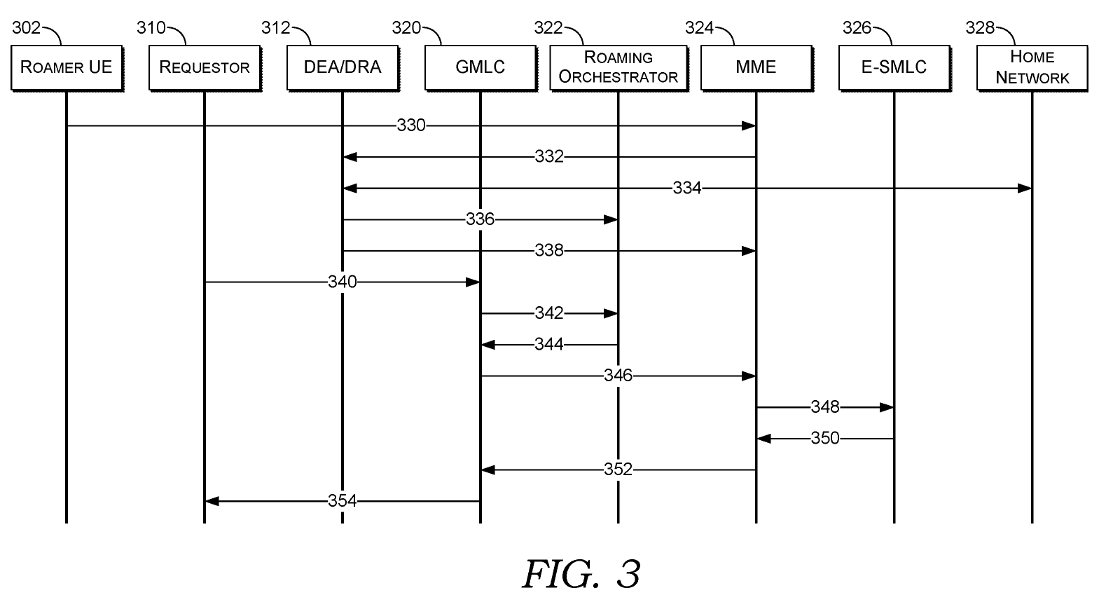

Turning now to FIG. 3, a call flow diagram is illustrated in accordance with one or more aspects of the present disclosure. A call flow 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs. The call flow 300 may generally include a roamer UE 302 (e.g., the UE 202 of FIG. 2), a requestor 310, a diameter edge agent (DEA) and/or a diameter routing agent (DRA) 312 (e.g., the DEA/DRA 223 of FIG. 2), a GMLC 320 (e.g., the GMLC 220 of FIG. 2), a roaming orchestrator 322 (e.g., the roaming orchestrator 222 of FIG. 2), an MME 324 (e.g., the MME 224 of FIG. 2), an E-SMLC 326 (e.g., the E-SMLC 226 of FIG. 2), and a home network 328 (e.g., the home network 230 of FIG. 2). Each of the preceding NFs may take different forms, including consolidated or distributed forms that perform the same general operations. In other architectures or protocols, the NFs may be given other names, however, the NFs herein refer to functions, not specifically identified components. For example, the MME 324 may alternatively be an access and mobility function (AMF), and the DEA/DRA 312 may be a security edge protection proxy (SEPP). The communications described below with respect to FIG. 3 may be configured according to one or more protocols (e.g., HTTP/2, JSON, diameter, s1 application protocol (S1AP)).

At a first step 330, the roamer UE 302 registers with the visiting network, such as with the MME 324. This initial communication may be an initial attach request of the roamer UE’s 302 to the MME 324. The initial communication may include a roamer identifier, such as an international mobile subscriber identity (IMSI), a mobile station international subscriber directory number (MSISDN), a mobile directory number (MDN), a temporary mobile subscriber identity (TMSI), and/or other identifiers unique to the roamer and/or the roamer’s UE 302. The initial communication may include additional information, such as access network information, the roamer UE’s 302 capability information, tracking area information, authentication information, and the like.

MMEs (e.g., the MME 324) of the visiting network indirectly communicate with home subscriber servers (HSSs) of the home network (e.g., the home network 328) to update the roamer’s location, which may be indirectly communicated through the DEA/DRA 312. For example, when a roamer initially uses the visiting network (e.g., the visiting network 212 of FIG. 2) and/or enters a new tracking area of an MME in the visiting network, the MME (e.g., the MME 324) will provide the roamer’s location (i.e., tracking area location, cell ID) to an HSS of the home network to update the roamer’s location within the HSS, such as in an update location request. At a second step 332, the MME 324 communicates an update location request to the DEA/DRA 312. At a third step 334, the DEA/DRA 312 communicates the update location request to the home network 328, and the DEA/DRA 312 receives an update location response from the home network 328. In aspects, the DEA/DRA 312 communicates and receives the update location messages from and to a home subscriber server (HSS) of the home network 328.

At a fourth step 336, the DEA/DRA 312 communicates a roaming location identifier to the roaming orchestrator 322. The DEA/DRA 312 may obtain this information from communications facilitated in the second step 332 and/or the third step 334. The fourth step 336 may occur before or after the third step 334. In some aspects, the DEA/DRA 312 forwards and/or copies and communicates the update location message of the second step 332 to the roaming orchestrator 322, and in other aspects, the DEA/DRA 312 communicates the roaming location identifier in a separate message to the roaming orchestrator 322. In some aspects, the DEA/DRA 312 forwards and/or copies and communicates the update location request and/or the update location response of the third step 334, and in other aspects, the roaming location identifier is communicated in a separate message. In aspects, the roaming location identifier is associated with a particular MME that the roamer is using while in the visiting network. In some aspects, the roaming location identifier is an identifier associated with a particular MME (e.g., an MME identifier (MMEI), an MME IP address, a global unique MME identifier (GUMMEI)). In other aspects, the roaming location identifier is a tracking area associated with the MME 324.

Prior to and/or during the fourth step 336, the DEA/DRA 312 and/or the roaming orchestrator 322 may incorporate an authentication procedure. In aspects, the communication of the fourth step 336 may be equipped with transport layer security (TLS) authentication and/or transport control protocol (TCP) authentication. For example, the DEA/DRA 312 may begin a handshake exchange, and once authenticated, the roaming orchestrator 322 may send a credential (e.g., a server certificate, token, key) verifying its identity and security. In aspects, the roaming orchestrator 322 may request a credential from the DEA/DRA 312. Once one or more of the DEA/DRA 312 and/or the roaming orchestrator 322 are authenticated, the DEA/DRA 312 may communicate the roaming location identifier to the roaming orchestrator 322.

At a fifth step 338, the DEA/DRA 312 communicates the update location response to the MME 324. In some aspects, the fourth step 336 occurs before the third step 334 is complete and/or before the fifth step 338 occurs, and in other aspects, the fourth step 336 occurs after the third step 334 is complete and/or after the fifth step 338 occurs. For example, the DEA/DRA 312 may learn of the roaming location identifier during the communication of 334 and elect to send the roaming location identifier to the roaming orchestrator 322 prior to the DEA/DRA 312 receiving the update location response from the home network 328 and/or prior to sending the update location response to the MME 324. In another illustrative example, the DEA/DRA 312 may communicate the roaming location identifier after receiving the update location response from the home network 328 and/or after sending the update location response to the MME 324.

At a sixth step 340, the requestor 310 requests location information associated with a particular roamer of the visiting network (e.g., the visiting network 212 of FIG. 2), and the GMLC 320 receives this request for location information. In aspects, the requesting entity may be a law enforcement agency (LEA). As used herein, law enforcement agency includes all governmental organizations that are authorized to enforce laws, investigate crimes, maintain public order, ensure national security, and/or protect the rights and safety of individuals and communities. LEAs may seek access to location information for purposes such as criminal investigations, national security, emergency response, and regulatory compliance. In such aspects, the request for location information may be a lawful intercept service request pursuant to a warrant or other legal authority. In other aspects, the requestor 310 may be the network operator itself, other non-governmental emergency service organizations, and the like. In aspects, the request for location information is an emergency location request, a location services (LCS) request, a periodic location request, a triggered location request, a mobile-terminated location request (MTL request), a vehicle location request, and the like.

The request for location information may include instruction or criteria information useful for the GMLC 320 to complete the request and/or the particular location information being requested by the requestor 310. In aspects, the request for location information may include a roamer identifier, such as the IMSI, the MSISDN, the MDN, and/or other identifiers unique to the roamer and/or the roamer’s UE 302, in the request for location information. The instruction or criteria information of the request for location information may include the identity of the requestor 310 and the purpose for the request for location (e.g., lawful interception, emergency assistance). Location information may include one or more types of location being requested (e.g., current location, last known location, periodic updates), one or more desired qualities of service for the location information (e.g., accuracy of location), and/or one or more requested natures of the location(s) (e.g., cell ID, enhanced cell ID, time of arrival, Wi-Fi positioning system (WPS), global positioning system (GPS), latitude and longitude). The request for location information may include a request for movement information of the roamer (e.g., velocity, altitude, change in location over time). The request for location information may include timestamps of location access, timestamps of roamer activity with the MME 224, and the like.

At a seventh step 342, the GMLC 320 requests a roaming location identifier from the roaming orchestrator 322, and the roaming orchestrator 322 receives the request for the roaming location identifier. In aspects, the request for the roaming location identifier may be a “GET” message configured in an HTTP protocol (e.g., HTTP/2). In other aspects, the request for the roaming location identifier are configured according to other protocols (e.g., diameter, S1AP, and the like). The request for the roaming location identifier may include the roamer identifier (e.g., the IMEI, MSISDN, MDN) to enable the roaming orchestrator 322 to determine the roaming location identifier (e.g., which MME and/or tracking area the roamer associated with the roamer identifier is connected to).

At an eighth step 344, the roaming orchestrator 322 communicates the roaming location identifier to the GMLC 320. In some aspects, the communication including the roaming location identifier may be the same as the update location message (e.g., the update location request and/or the update location response) received from the DEA/DRA 312 in the fourth step 336. In such aspects, the update location message may be altered or adjusted by the roaming orchestrator 322 before being communicated to the GMLC 320. For example, the GMLC 320 may not need the other information in the update location message outside of the roaming location identifier, and thus the DEA/DRA 312 may remove all other information besides the roaming location identifier before communicating the roaming location identifier to the roaming orchestrator 322. In other aspects, the communication including the roaming location identifier is a separate message distinct from the update location request and/or response of the second step 332, the third step 334 and/or the fifth step 338.

Based on the roaming location identifier, the GMLC 320 may determine which MME (e.g., the MME 324) the roamer is connected to, and thus, which MME to request location information from. In aspects where the roaming location identifier is a tracking area of an MME, the GMLC 320 may determine which MME to request location information from by comparing the tracking area with a database of MMEs and associated tracking area. In aspects where the roaming location identifier is an MME identifier, the GMLC 320 uses the MME identifier to determine which MME to request location information from.

At a ninth step 346, the GMLC 320 requests location information associated with the roamer from the MME 324 associated with the roaming location identifier, and the MME 324 receives the request for location information. As described above, the roaming location identifier is associated with the identity of the MME 324 and/or the tracking area of the MME 324. In some aspects, the request for location information from the GMLC 320 and the MME 324 is a provide location request, and in other aspects, the request may take other forms or have other formats (e.g., provide subscriber location request, LCS-request, and the like). The request for location information from the GMLC 220 may additionally include one or more roamer identifiers, one or more types of location being requested, one or more requested accuracies of the location(s), and/or one or more requested natures of the location(s), as described above with respect to the sixth step 340.

At a tenth step 348, the MME 324 requests the location information from the E-SMLC 326, and the E-SMLC 326 receives the request for location information from the MME 324. The request may include one or more roamer identifiers, one or more types of location being requested, one or more requested accuracies of the location(s) and/or one or more requested natures of the location(s) (e.g., GPS, Wi-Fi positioning, cell ID, and the like), as described above with respect to the sixth step 340. In aspects, the request for location information is a serving mobile location center protocol (SLP) location request, and in other aspects, the request for location information takes other forms or formats (e.g., LCS-request, provide subscriber location request, and the like).

At an eleventh step 350, the E-SMLC 326 communicates the location information to the MME 324, and the MME 324 receives the location information from the E-SMLC 326. The E-SMLC 326 may determine the roamer’s location based on the one or more roamer identifiers provided by the MME 324. The E-SMLC 326 may determine the roamer’s location using one or more methods (e.g., cell-tower triangulation, Wi-Fi positioning, global positioning, time difference of arrival, enhanced cell ID, and the like). The location information may include any one or more of the requested location information requested by the requestor 310, as described with respect to the first step 330. For example, the location information communicated to the MME 324 may include one or more locations of the roamer, as well as additional location information (e.g., another format of location, timestamps, velocity, accuracy information related to the location data).

At a twelfth step 352, the MME 324 communicates the location information to the GMLC 320, and the GMLC 320 receives the location information from the MME 324. In aspects, the MME 324 communicates the location information in a provide location response, and in other aspects, the MME 324 communicates the received location information in a message with another form or format (e.g., provide subscriber location response, LCS-response, and the like). The response to the GMLC 320 may include one or more roamer identifiers to assist the GMLC 320 in fulfilling the request for the requestor 310. The location information may include any one or more of the requested location information requested by the requestor 310, as described with respect to the first step 330.

At a thirteenth step 354, the GMLC 320 communicates the location information to the requestor 310, and the requestor 310 receives the location information. In some aspects, the communication to the requestor 310 is a lawful intercept service response, and in other aspects, the communication to the requestor 310 takes other forms (e.g., emergency location response, LCS response, periodic location response, triggered location response, a MTL response, a vehicle location response). The location information may include any one or more of the requested location information requested by the requestor 310, as described with respect to the first step 330. For example, the response to the requestor 310 may include one or more forms of the location of the roamer (e.g., a single GPS fix, a GPS fix and cell-tower triangulation), one or more roamer identifiers (e.g., IMSI, MSISDN), one or more accuracies for the provided location, and the like.

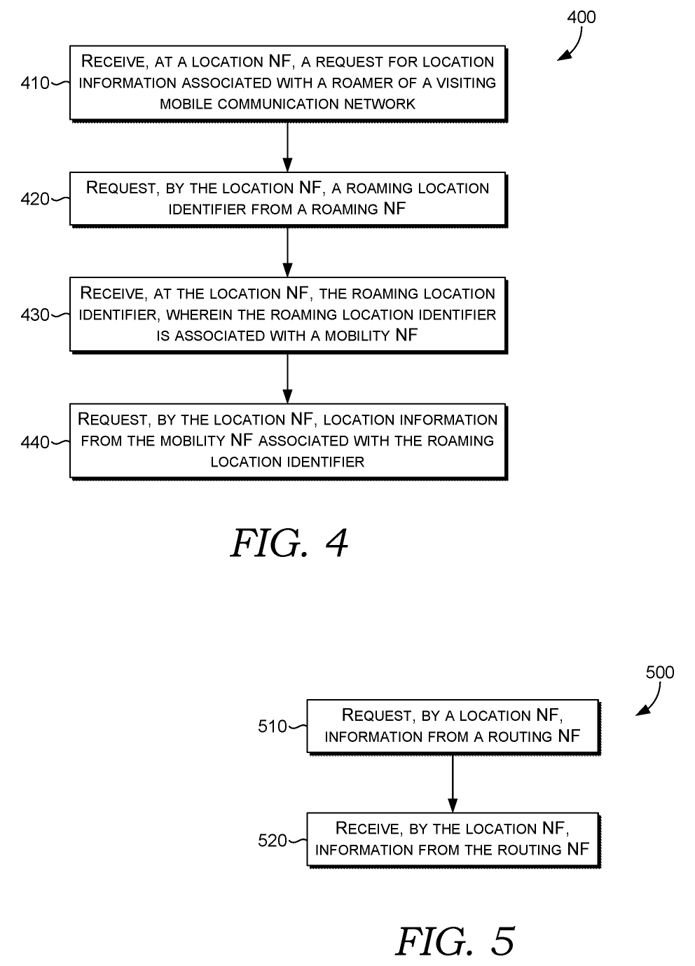

Turning now to FIG. 4, a flow chart is provided that illustrates one or more aspects of the present disclosure relating to a method 400 for determining location information of a roamer of a visiting mobile communication network (e.g., the visiting network 212 of FIG. 2). The method 400 may include one or more aspects described with respect to FIGS. 1-3.

At a first step 410, a location NF receives a request for location information associated with a roamer of the visiting mobile communication network. The request for location information associated with a roamer is described with respect to FIG. 3. In some aspects, the request is from a LEA. In aspects, the location NF is a GMLC (e.g., the GMLC 220 of FIG. 2, the GMLC 320 of FIG. 3), and in other aspects, the location NF is a location retrieval function (LRF), a LCS server, a position determining entity (PDE), and/or a location management function (LMF). At a second step 420, the location NF requests a roaming location identifier from a roaming NF. In some aspects, the roaming NF is a roaming orchestrator (e.g., the roaming orchestrator 222 of FIG. 2, the roaming orchestrator 322 of FIG. 3), such as a roaming customer experience management (RCEM) function. In other aspects, the roaming NF is another roaming NF.

At a third step 430, the location NF receives the roaming location identifier. The roaming location identifier is associated with a mobility NF. In some aspects, the mobility NF is an MME (e.g., the MME 224 of FIG. 2, the MME 324 of FIG. 3), and in other aspects, the mobility NF is an AMF. The roaming location identifier may have one or more aspects as described with respect to FIG. 3. At a fourth step 440, the location NF requests location information from the mobility NF associated with the roaming location identifier. The request for location information may have one or more features described with respect to FIG. 3. The mobility NF may request the location information from a second location NF. In aspects, the second location NF is an E-SMLC (e.g., the E-SMLC 226 of FIG. 2, the E-SMLC 326 of FIG. 3), and in other aspects, the second location NF is a LRF, a LCS server, a PDE, and/or a LMF. The mobility NF may receive the location information from the second location NF, as described with respect to FIG. 3. The mobility NF may communicate the location information to the location NF. As a result, the location NF may fulfill the request for location information associated with a roamer, as described with respect to FIG. 3.

Turning now to FIG. 5, a flow chart is provided that illustrates one or more aspects of the present disclosure relating to a method 500 for exchanging information between a location NF and a roaming NF. The method 500 may include one or more aspects described with respect to FIGS. 1-4. At a first step 510, a location NF requests information from a routing NF. In aspects, the information includes a roaming location identifier, as described with respect to FIGS. 3-4. At a second step 520, the location NF receives the information from the routing NF. In aspects, the location NF is a GMLC (e.g., the GMLC 220 of FIG. 2, the GMLC 320 of FIG. 3), and the routing NF is a roaming orchestrator (e.g., the roaming orchestrator 222 of FIG. 2, the roaming orchestrator 322 of FIG. 3). In such aspects, the routing NF may be a RCEM function. In aspects, the location NF uses the received information to fulfill one or more requests associated with a roamer. For example, the location NF may use the information to fulfill a request for location information of a roamer in a visiting network, as described with respect to FIG. 3.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for determining location information of a roamer of a visiting mobile communication network, the method comprising:
receiving, at a location NF, a request for location information associated with the roamer of the visiting mobile communication network;
requesting, by the location NF, a roaming location identifier from a roaming NF;
receiving, at the location NF, the roaming location identifier, wherein the roaming location identifier is associated with a mobility NF; and
requesting, by the location NF, the location information from the mobility NF associated with the roaming location identifier.

2. The method of claim 1, wherein the roaming location identifier is a tracking area and wherein the mobility NF associated with the tracking area serves the tracking area.

3. The method of claim 1, wherein the roaming location identifier is an identity of the mobility NF.

4. The method of claim 1, wherein the location NF is a gateway mobile location center (GMLC).

5. The method of claim 1, wherein the roaming NF is a roaming orchestrator.

6. The method of claim 1, wherein the mobility NF is a mobility management function (MME).

7. The method of claim 1, wherein the mobility NF is an access and mobility function (AMF).

8. The method of claim 1, wherein at least a portion of the visiting mobile communication network operates using S8 home routing (S8HR) architecture.

9. The method of claim 1, wherein the request for the location information associated with the roamer of the visiting mobile communication network is requested by a law enforcement agency (LEA).

10. A method for determining location information of a roamer of a visiting mobile communication network of a mobile communication network, the method comprising:
receiving, at a first location NF, a request for location information associated with the roamer of the visiting mobile communication network;
requesting, by the first location NF, a roaming location identifier from a roaming NF;
communicating, by the roaming NF, the roaming location identifier to the first location NF, wherein the roaming location identifier is associated with a mobility NF; and
requesting, by the first location NF, the location information from the mobility NF associated with the roaming location identifier.

11. The method of claim 10, wherein the roaming location identifier is a tracking area associated with the mobility NF.

12. The method of claim 10, wherein the roaming location identifier is an identity of the mobility NF.

13. The method of claim 10, further comprising:
requesting, by the mobility NF, the location information from a second location NF;
receiving, by the mobility NF, the location information from the second location NF; and
communicating, by the mobility NF, the location information to the first location NF.

14. The method of claim 13, wherein the request for the location information associated with the roamer of the visiting mobile communication network is a mobile-terminated location (MTL) request.

15. The method of claim 14, wherein the first location NF is a gateway mobile location center (GMLC).

16. The method of claim 15, wherein the roaming NF is a roaming orchestrator.

17. The method of claim 16, wherein the mobility NF is a mobility management function (MME).

18. The method of claim 16, wherein the mobility NF is an access and mobility management function (AMF).

19. The method of claim 17, wherein the second location NF is an evolved serving mobile location center (E-SMLC).

20. A system for exchanging information between a location NF and a roaming NF, the system comprising:
one or more computer processing components configured to execute operations comprising:
requesting, by the location NF, the information from the roaming NF; and
receiving, by the location NF, the information from the roaming NF.
